(19) United States
(12) Patent Application Publication
(10) Pub. No.: US 2019/0138926 A1
(43) Pub. Date: May 9, 2019

(54) Degradation modeling and lifetime prediction method considering effective shocks

(71) Applicant: BEIHANG UNIVERSITY, Beijing (CN)

(72) Inventors: Tingting Huang, Beijing (CN); Bo Peng, Beijing (CN); Shunkun Yang, Beijing (CN); Shanggang Wang, Beijing (CN); Yuepu Zhao, Beijing (CN); Zixuan Yu, Beijing (CN); Chenbo Du, Beijing (CN)

(73) Assignee: BEIHANG UNIVERSITY

(21) Appl. No.: 16/228,804

(22) Filed: Dec. 21, 2018

(30) Foreign Application Priority Data
Dec. 22, 2017 (CN) 201711403820.5

(51) Int. Cl. G06N 7/00; G06F 17/18

(52) U.S. Cl. CPC G06N 7/005; G06F 17/18

(57) ABSTRACT

A degradation modeling and lifetime prediction method considering effective shocks includes steps of: first collecting degradation test data, then establishing a performance degradation model, and determining an environment or load changing rate threshold of a product subjected to effective shock based on the test data; estimating parameters in the model, and determining effective shock occurrence times based on the future environmental or load profile, and finally preforming lifetime and reliability prediction. Specific steps are as follows: step 1: collecting degradation test data; step 2: establishing a degradation model; step 3: determining an environment or load changing rate threshold; step 4: estimating the parameters; step 5: predicting the times that effective shocks occur; and step 6: performing reliability prediction. The present invention considers effects of effective shocks caused by sharp environment or load changes on product performance degradation, which makes the prediction method more realistic and improves the prediction accuracy.

### CROSS REFERENCE OF RELATED APPLICATION

The present invention claims priority under 35 U.S.C. 119(a-d) to CN 201711403820.5, filed Dec. 22, 2017.

### BACKGROUND OF THE PRESENT INVENTION

### Field of Invention

The present invention relates to a degradation modeling and lifetime prediction method considering effective shocks, belonging to a technical field of degradation modeling and lifetime prediction.

### Description of Related Arts

With the development of science and technology, the reliability requirements of products are increasing. Especially in the industry such as aeronautics, astronautics, electronics, and ships, the lifetime and reliability of key components of systems and equipment are of vital importance. For products with long lifetime and high reliability, the performance degradation modeling method is usually used to predict the lifetime of the product. The conventional degradation modeling method mainly focuses on constant environmental conditions. However, in the actual use of the product, the environment and load that the product explored to may change with time, so the accuracy of lifetime prediction based on the conventional method is not high enough. In recent years, the degradation modeling and lifetime prediction technology in time-varying environment has become a hot topic.

The existing degradation modeling methods considering time-varying environments are mainly divided into three categories, (1) considering the effect of random shocks of time-varying environment or load on products; (2) considering the effect of time-varying environment or load on product degradation rate, without considering any shock damage; and (3) considering the effect of the time-varying environment on the degradation rate and the shock damage to the product. Although researchers have done a lot of research on the degradation modeling in time-varying environments in recent years, there are still many deficiencies, most of which consider degradation process and shock process separately, which is not always consistent with the actual situation. Although the methods in (3) consider the effect of the time-varying environment on both the product performance degradation rate and shock damage, for the shock damage part, only random shocks of the time-varying environment or instantaneous shocks of the environmental stress transition on the product were considered, while effective shocks caused by sharp changes in environmental stress in the real use field is not considered in literature. It might result in an inaccurate product lifetime prediction, and may also lead to errors in major decisions such as product replacement and condition-based maintenance based on the predicted product lifetime. In order to improve the prediction accuracy, we propose a degradation modeling and lifetime prediction method that considers effective shocks.

Before introducing the present invention, we will first review the existing research of degradation modeling:

a) Degradation Modeling Under Constant Environmental Conditions

Conventional degradation modeling and lifetime prediction methods are mainly performed under constant environmental conditions. In 1969, Gertsbackh and Kordonskiy [Gertsbakh, I., and Kordonskiy, K. Models of failure [J]. Springer-Verlag, 1969.]proposed the use of performance degradation data to evaluate product reliability, and proposed a linear model with both slope and intercept as random parameters. Lu and Meeker [Lu, C., and Meeker, Q. Using degradation measures to estimate a time-to-failure distribution [J]. Technimetrics, 1993, 35(2):161-174.] proposed a general method to describe the degradation path based on the random coefficient regression model, which describes the degradation measurement at any moment as the sum of the actual path part and the random error part, wherein the actual path part includes the fixed effect part and random effect part. The fixed effect part describes the same degradation trend for all samples, while the random effect part describes the individual-specific degradation trend. Weaver and Meeker [Weaver, B., and Meeker, W. Methods for planning repeated measures accelerated degradation tests [M]. John Wiley and Sons Ltd. 2014.] studied the optimal design of repetitive measurement degradation, and realized the method of optimizing accelerated repetitive degradation research. During the degradation process, the intrinsic characteristics of the product have its uncertainty with time. Therefore, some researchers began to use the stochastic process model to describe the degradation path of the product. Liao and Elsayed [Liao, H., and Elsayed, E. Reliability prediction and test plan based on an accelerated degradation rate model [J]. International Journal of Materials & Product Technology, 2004, 21(5): 402-422 (21).] raised a stochastic process model with independent increments to describe the degradation trend of samples. Wang [Wang, X. Wiener processes with random effects for degradation data [J]. Journal of Multivariate Analysis, 2010, 101(2): 340-351.] considered the difference between the different samples in the sample degradation process, and established a Wiener degradation model with random effects. Noortwijk [Northwick, V. A survey of the application of gamma processes in maintenance [J]. Reliability Engineering & System Safety, 2009, 94(1): 2-21.] described the application of the Gamma process in reliability maintainability research. Bagdonavicius and Nikulin [Bagdonavicius, V., and Nikulin, M. Estimation in degradation models with explanatory variables. [J]. Lifetime Data Analysis, 2001, 7(1): 85-103.] used the Gamma process to express the degradation process of the product, and proposed the product performance degradation modeling and lifetime prediction method with covariates.

Degradation modeling considering environmental factors under constant environmental conditions is based on data and analysis results of accelerated degradation tests, and establishes a model of product performance degradation in a given environmental condition. Although such methods consider environmental factors, they still assume that environmental factors are constant. Accelerated testing is to expose the product to multiple high stress levels, so as to accelerate its degradation process. A degradation model considering stress levels is established by analyzing the performance degradation measurements of the product under various higher stress levels, so as to predict the lifetime and reliability of the product under lower stress levels. Eghbali [Eghbali, G. Reliability estimate using accelerated degradation data. Piscataway [J]. USA: Rutgers University, 2000.] proposed a geometric Brownian motion degradation rate model. Huang and Li [Huang, T., and Li, Z. Accelerated proportional degradation hazards-odds model in accelerated degradation test [J]. Journal of Systems Engineering to and Electronics, 2015, 26(2): 397-406.] proposed an accelerated proportional degradation hazards-odds model.

b) Performance Degradation Modeling Under Time-Varying Conditions

Performance degradation modeling under time-varying conditions has released the assumption that the environment keep constant, which is more consistent with the actual field use of many products. The existing degradation modeling methods considering time-varying environment are mainly divided into three categories, which are described as follows.

(1) Random Shock Model

In a time-varying environment, products are affected by the random shocks in the external environment. There has been a lot of detailed and in-depth existing research on random shock models. Ross [Ross, M. Generalized Poisson shock models [J]. Annals of Probability, 1981, 9(5): 896-898.] discussed the general shock model in detail; Finkelstein and Zarudnij [Finkelstein, S., and Zarudnij, I. A shock process with a non-cumulative damage [J]. Reliability Engineering & System Safety, 2001, 71(1):103-107.] studied Poisson shock process for non-cumulative damage; Sinpurwalla [Singpurwalla, D. Survival in dynamic environments [J]. Statistical Science, 1995, 10(1): 86-103.] discussed the survival characteristics of products in a changing environment; and Nakagawa [Nakagawa, T. Shock and damage models in reliability theory [M]. Springer London, 2007.] discussed two types of shock damage models: cumulative shock model and extreme shock model. In engineering applications, when the total damage caused by the shock can be added, the cumulative shock model is adopted, and when the total shock damage cannot be added, the extreme shock model is utilized. Product fails when the shock magnitude exceeds the threshold for the first time in the extreme shock model. Two typical examples of extreme shock models are cracks in fragile materials such as glass, and product failures in semiconductor materials due to excessive current or excessive voltage. In addition, Gut [Gut, A. Mixed shock models [J]. Bernoulli, 2001, 7(3): 541-555.] proposed a mixed shock model, considering both cumulative shock model and extreme shock model.

(2) The Effect of Time-Varying Environment on Product Degradation Rate

The time-varying environment not only cause shock damage to the product, but also affect the degradation rate of the product. Liao and Tian [Liao, H., and Tian, Z. A framework for predicting the remaining useful lifetime of a single unit under time-varying operating conditions [J].], and Bian and Gebraeel [Bian, L., and Gebraeel, N. Stochastic methodology for prognostics under cooling varying environmental profiles [J]. Statistical Analysis & Data Mining, 2013, 6(3): 260-270.] proposed linear degradation rate model and nonlinear degradation rate model of product based on Brownian motion under dynamic conditions. Cinlar [Cinlar, E. Shock and wear models and Markov additive processes [J]. In Shimi, I. and Tsokos, C. editors, Theory and Applications of Reliability, pages 193-214. Academic Press.] utilized the Markov process to express environmental effects and described the degradation process based on an additive Levy process. Most of the existing performance degradation models under dynamic conditions separate the shock process and degradation process. However, in many cases, these two situations may exist simultaneously during product usage life, and should be considered simultaneously in degradation models.

(3) Modeling Continuous Degradation with Shocks

Since the product performance follows a natural degradation process of the material, and is also affected by the external shocks, it is necessary to consider both factors in the product reliability analysis to describe the actual degradation process of the product performance accurately. Li and Pham [Li, W., and Pham, H. Reliability modeling of multi-state degraded systems with multi-competing failures and random shocks [J]. IEEE Transactions on Reliability. 2005, 54(2): 297-303] proposed a model that considers the effect of time-varying environment on product degradation rate and the cumulative shocks occurred during this period. Kharoufeh et al. [Kharoufeh, J. P., Finkelstein, D. E., and Mixon, D. G. Availability of periodically inspected systems with Markovian wear and shocks [J]. Journal of Applied Probability, 2006, 43(2): 303-317.] considered the Poisson shock due to the random environment based on the original degradation model. Song et al. [Song, S., Coit, D., and Qian, M. Reliability for systems of degrading components with distinct component shock sets [J]. Reliability Engineering System Safety, 2014, 132(132): 115-124] used random shocks to describe the effect of random environment on the performance degradation process, and in their model, random shocks cause the performance degradation signals increasing or decreasing immediately. Wang et al. [Wang, Z., Huang, H. Z., and Li, Y. An approach to reliability assessment under degradation and shock process [J]. IEEE Transactions on Reliability, 2011, 60(4):852-863.] considered both the degradation process and random shocks, and shocks can also affect degradation rate of products.

In engineering applications, in addition to random shocks, when there is environmental or load transition, it causes instantaneous shock damage to the products. Bian et al. [Bian, L., Gebraeel, N., and Kharoufeh, J. Degradation modeling for real-time estimation of residual lifetimes in dynamic environments [J]. IIE Transactions, 2014, 47(5): 471-486(16).] analyzed the instantaneous shock caused by environmental transitions, and proposed a degradation model based on Brownian motion with degradation rate function and instantaneous shock function.

Although researchers have done a lot of research on degradation modeling under time-varying environments in recent years, there are still some shortcomings. Most of the models consider degradation process and shock process separately, that is to say, they only consider the effect of random shock on product in time-varying environment, or only consider the effect of time-varying environment on the degradation rate without shocks, which are not consistent with the actual applications. Some models consider degradation process in time-varying environments with random shocks or shocks caused by stress transitions. However, for some products, although environment or load has no sudden change, when it changes fast enough, an effective shock may also occur to the product. This type of shock damage has not been considered in previous research. Therefore, in response to this situation, the present invention proposes a degradation modeling and lifetime prediction method that considers effective shocks, so as to present a method to solve the current problems in this field.

### SUMMARY OF THE PRESENT INVENTION

### I. Object of the Present Invention

The existing degradation models for products in a time-varying environment consider the effect of shocks on product performance degradation rate and degradation signal, and only instantaneous shocks are considered. However, effective shocks may also occur in time-varying environment when there are sharp enough stress-changing rates of stress levels. Therefore, existing methods are insufficient to solve engineering problems for the cases that effective shocks occur. An object of the present invention is to provide a degradation modeling and lifetime prediction method considering effective shocks for products in a time-varying environment, which combines the effects of environmental and load changes on the degradation rate of product, and the effects of effective shocks on degradation signals caused by sharp change of stress levels with a Wiener process-based degradation model, so as to establish a relationship between the environmental and load changes and the product degradation signals for the purpose of degradation modeling and lifetime prediction.

### II. Technical Scheme of the Present Invention

The present invention provides a degradation modeling and lifetime prediction method considering effective shocks, an overall technical scheme is shown in FIG. 1, comprising steps of: first collecting degradation test data, then establishing a degradation model for degradation signals, and determining a threshold of stress-changing rate of environmental or load change for an effective shock to occur; estimating parameters in the model, and finally determining an effective shock occurrence time based on the future stress profile, and performing lifetime and reliability prediction. Specific steps are as follows:

Step 1: Collecting Degradation Test Data

wherein product performance degradation data are collected through experiments or engineering applications; based on a time-varying environmental or a load profile, the product performance degradation data and corresponding environmental or load levels are acquired once in a pre-specified time interval, and then stored in real time;

Step 2: Establishing a Degradation Model

wherein a performance degradation model based on Wiener process including degradation rate function and effective shock function is expressed as follows:

$$X ( t ) = X ( 0 ) + {\int }_{0}^{t} r ( w ( v ) ) dv + σ B ( t ) + {\sum }_{j = 1}^{N ( t )} S ( w ( {τ}_{j} ) )$$

wherein X(0) is the value of degradation signal that describes product performance at an initial time; B(t) is a standard Wiener process;

σ is the diffusion parameter, which describes the inconsistency and instability in a product degradation process, and does not change with time and conditions, thus it is assumed to be a constant; σB(t)˜N(0,σ²t); w(t) is the level of environment or load at time t; ν is a variable in an integral formula, which has an upper limit of t and a lower limit of 0;

r(w(t)) is the product performance degradation rate, which is a deterministic function related to the environment and the load; when the environmental stress is electrical stress, the power law model r(w(t))=aw(t)^{b} can be utilized to describe the degradation rate; when the environmental stress is temperature, an Arrhenius model r(w(t))=ae^{-b/w(t)} is adopted;

S(w(τⱼ)) is the effect of effective shocks on degradation signals, wherein τⱼ is a time when the j-th effective shock occurs, j=1, 2, . . . , N(t), N(t) is the number of effective shocks occur until time 1.

Effective shock is defined as follows;

when the environment or load changes fast enough, which means the environment or load changing rate is greater than a certain threshold, it is likely to cause certain shock damage to the product; referring to FIG. 2, from the time τⱼ⁻, the environmental changing rate is greater than a threshold value l, namely w′(τⱼ⁻)≥l; when the sharp change of stress level remains for a sufficient time period Δτⱼ, the effective shock will occur at τⱼ; on the countrary, if the time period Δτⱼ is not long enough, no effective shock occurs;

based on the above analysis, the time r that the j-th effective shock occurs is defined as:

$$\begin{matrix}{τ}_{j} = inf \{ {τ}_{j}^{-} \leq t \leq {τ}_{j}^{+} \text{:} \frac{γ}{( w ( t ) - w ( {τ}_{j}^{-} ) ) \text{/} ( t - {τ}_{j}^{-} )} + {τ}_{j}^{-} \leq t , \} \\ = inf \{ {τ}_{j}^{-} \leq t \leq {τ}_{j}^{+} \text{:} ( w ( t ) - w ( {τ}_{j}^{-} ) ) \geq γ \}\end{matrix}$$

wherein τⱼ⁻ and τⱼ⁺ are the start time and end time of a time period in which an environment or load changing rate is greater than a threshold value l, i.e., w′(t)≥l within a time interval [τⱼ⁻, τⱼ⁺], γ is a parameter to be estimated, w(t) is an environmental or load level at the time t, w(τⱼ⁻) is an environment or load level at the time τⱼ⁻;

an effective shock model is expressed as follows:

$$S ( w ( {τ}_{j} ) ) = α ( w ( {τ}_{j} ) - w ( {τ}_{j}^{-} ) ) exp ( - \frac{β}{( w ( {τ}_{j} ) - w ( {τ}_{j}^{-} ) ) \text{/} ( {τ}_{j} - {τ}_{j}^{-} )} )$$

wherein α and β are parameters to be estimated;

Step 3: Determining the Environment or Load Changing Rate Threshold

based on the present invention, when the environment or load changes fast enough, namely when the environment or load changing rate exceeds a certain threshold, the effective shock may occur; in engineering applications, the corresponding environment or load changing rate thresholds for different products are also different; therefore, before parameter estimation, the environment or load changing rate threshold l is determined based on historical data; an estimation method of threshold l is as follows:

(1) according to engineering experience, effective shocks are considered only for the conditions that environment or load increases since effective shock is unlikely to occur when the environment or load decreases; according to an environmental or load profile, calculating the average changing rate w̅′ᵢ of a monotonically increasing time period of the environment or load stress, i=1, 2, . . . , n, which represents the i-th time period of a monotonically increasing environment or load stress profile;

(2) finding the time periods during which the effective shock occurs according to historical degradation data, wherein the corresponding environment or load stress average changing rates are certainly greater than the threshold; on the contrary, environment or load average changing rates of other monotonically increasing time periods of the environment or load stress with no effective shock are less than the threshold, thereby estimating the environmental changing rate threshold based on historical data;

firstly, determining the time periods during which the effective shock occurs based on the degradation data, obtaining the corresponding environment or load stress average changing rates, and finding the minimum value w̅′ₘ, wherein w̅′ₘ is the minimum value of the environment or load changing rate that the effective shock occurs;

secondly, finding the environment or load average changing rate of other monotonically increasing time periods of the environment or load stress with no effective shock, and obtaining the maximum value w̅′ₖ, wherein w̅′ₖ is the maximum value of the environment or load changing rate that the effective shock does not occur; and

(3) according to engineering applications, using the mean value of w̅′ₘ and w̅′ₖ as the environment or load changing rate threshold l,

$$l = {\overline{w}}_{k}^{′} + \frac{{\overline{w}}_{m}^{′} - {\overline{w}}_{k}^{′}}{2}$$

wherein for some special cases, the effective shock occurs in all environment or load time periods that environment or load stress increases, and thus it is impossible to determine the maximum value w̅′ₖ of the environment changing rate that the effective shock does not occur; therefore, the environment or load changing rate threshold l is set as the minimum value w̅′ₘ of the environment or load changing rate that the effective shock occurs,

l=w̅′ₘ

Step 4: Estimating the Parameters and Updating the Model in Real Time

wherein a maximum likelihood method and a least square method are used to estimate the parameters, the power law model r(w(t))=aw(t)^{b} is taken as an example to describe the degradation rate, the degradation model is approximated as,

$$X ( t ) \approx X ( 0 ) + {\sum }_{i = 1}^{m} r ( w ( {t}_{i} ) ) Δ {t}_{i} + σ B ( t ) + {\sum }_{j = 1}^{N ( t )} S ( w ( {τ}_{j} ) )$$

wherein m is the cumulative observation number of degradation signals before time t, N(t) is the number of effective shocks occur before time t; w(tᵢ) is the environment or load level at the time tᵢ, r(w(tᵢ)) is the degradation rate at time tᵢ with environment or load level w(tᵢ), Δtᵢ is the time interval between tᵢ₋₁ and tᵢ;

the parameters α, β, and γ in the effective shock model are estimated by the least square method,

first, the effective shock model is rewritten as,

ln(S(w(τⱼ)))−ln((w(τⱼ)−w(τⱼ⁻))=ln(α)+{−(τⱼ−τⱼ⁻)/(w(τⱼ)−w(τⱼ⁻))}·β

denoting,

yⱼ=ln(S(w(τⱼ)))−ln((w(τⱼ)−w(τⱼ⁻)))

xⱼ=−(τⱼ−τⱼ⁻)/(w(τⱼ)−w(τⱼ⁻))

then estimates of the parameters are obtained as,

$$ln ( \hat{α} ) = \overline{y} - \hat{β} \overline{x}$$

$$\hat{β} = \frac{{\sum }_{j = 1}^{n} ( {x}_{j} - \overline{x} ) ( {y}_{j} - \overline{y} )}{{\sum }_{j = 1}^{n} {( {x}_{j} - \overline{x} )}^{2}}$$

$$\hat{γ} = \frac{1}{n} {\sum }_{j = 1}^{n} ( w ( {τ}_{j} ) - w ( {τ}_{j}^{′} ) )$$

$$wherein , \\ \overline{x} = \frac{1}{n} {\sum }_{j = 1}^{n} {x}_{j} = \frac{1}{n} {\sum }_{j = 1}^{n} [ - ( {τ}_{j} - {τ}_{j}^{-} ) \text{/} ( w ( {τ}_{j} ) - w ( {τ}_{j}^{-} ) ) ]$$

$$\overline{y} = \frac{1}{n} {\sum }_{j = 1}^{n} {y}_{j} = \frac{1}{n} {\sum }_{j = 1}^{n} [ ln ( S ( w ( {τ}_{j} ) ) ) - ln ( ( w ( {τ}_{j} ) - w ( {τ}_{j}^{-} ) ) ) ]$$

xⱼ, yⱼ, x and y are just established to simplify formula expressions;

the parameters in the degradation rate function and the diffusion parameter are estimated by the maximum likelihood method; in order to simplify calculation, effective shock cumulative damage terms in the data are subtracted:

$$H ( t ) = X ( t ) - {\sum }_{j = 1}^{N ( t )} S ( w ( {τ}_{j} ) )$$

wherein H(t) is the degradation model after subtracting effective shock cumulative damage;

then the degradation model is rewritten as,

$$H ( t ) \approx X ( 0 ) + {\sum }_{i = 1}^{m} r ( w ( {t}_{i} ) ) Δ {t}_{i} + σ B ( t )$$

based on the property that Wiener process has independent increments, then,

ΔH(tᵢ)˜N(r(w(τᵢ))Δtᵢ,σ²Δtᵢ)

wherein ΔH (tᵢ) is the increment of the degradation signal;

the maximum likelihood method is used to estimate parameters and therefore the likelihood function of the degradation model is obtained:

$$L ( σ , a , b ) = {\prod }_{i = 1}^{m} \frac{1}{σ \sqrt{2 πΔ {t}_{i}}} exp [ - \frac{{( Δ H ( {t}_{i} ) - {a ( w ( {t}_{i} ) )}^{b} Δ {t}_{i} )}^{2}}{2 {σ}^{2} Δ {t}_{i}} ]$$

wherein the parameters α, β and γ are estimated by calculating first-order partial derivative of the log-likelihood function for each of the parameters, and further equalizing to 0;

Step 5: Predicting the Time that Effective Shocks Occur

wherein the time that effective shocks occurs are predicted before performing reliability and lifetime prediction;

according to the environment or load changing rate threshold l and a future environmental or load profile, the time that effective shocks occur can be predicted,

for the time periods when the environment or load changing rates are greater than the threshold l,

τⱼ⁻≤∀t≤τⱼ⁺,w′(t)≥l

the time that the j-th effective shock occurs τⱼ is predicted by performing a point-by-point analysis on the time t in the time period [τⱼ⁻, τⱼ⁺],

$${τ}_{j} = inf \{ {τ}_{j}^{-} \leq t \leq {τ}_{j}^{+} \text{:} \frac{γ}{( w ( t ) - w ( {τ}_{j}^{-} ) ) \text{/} ( t - {τ}_{j}^{-} )} + {τ}_{j}^{-} \leq t , \}$$

wherein τⱼ is the time when the j-th effective shock occurs;

if,

$$\frac{γ}{( w ( t ) - w ( {τ}_{j}^{-} ) ) \text{/} ( t - {τ}_{j}^{-} )} + {τ}_{j}^{-} \geq t , {τ}_{j}^{-} \leq t \leq {τ}_{j}^{+}$$

then no effective shock occurs before the time t; and

Step 6: Performing the Lifetime and Reliability Prediction

wherein 1) is assumed to be the failure threshold and T is the time when the degradation signal exceeds the threshold for the first time; the product performance degradation data of products are collected through the experiment; tₖ is assumed to be the time point for collecting a last data set, tₖ<T, then w(t) represents a future environmental or load profile from tₖ to T, tₖ<t<T; thus, the degradation process based on the future environmental or load profile is expressed as:

$${X}^{k} ( t ) = X ( {t}_{k} ) + {\int }_{{t}_{k}}^{t} r ( w ( v ) ) dv + {\sum }_{j ∈ {V}_{k} ( t )}^{N ( t )} S ( w ( {τ}_{j} ) ) + σ B ( t - {t}_{k} )$$

wherein Vₖ(t)≡{j:τⱼ∈(tₖ,t]}, N(t) is the number of the effective shocks before the time t, X(tₖ) is the degradation value at the time tₖ;

then the distribution when the degradation value X(t) exceeds the threshold for the first time is expressed as:

T=inf{t>0:X(t)≥D}

then a reliability model is: R(t)=1−∫₀^{t}ƒ′(ν)dν,

wherein ƒ(t) is the probability density function, in f(ν), ν is an independent variable with the upper limit of t and the lower limit of 0; an expression of ƒ(t) is obtained by applying a boundary tangent method of Daniels [Daniels, H. E. Approximating the first crossing-time density for a curved boundary, Bernoulli 2(2) (1996), 133-143] to estimate a tangential approximation method of a density function exceeding for a first time:

$$f ( t ) = \frac{1}{\sqrt{2 π t}} ( \frac{D - X ( 0 ) - {\int }_{0}^{t} r ( w ( v ) ) dv - {\sum }_{i = 1}^{N ( t )} S ( w ( {τ}_{j} ) ) + r ( w ( t ) ) t}{t σ} ) \cdot exp ( - \frac{{( D - X ( 0 ) - {\int }_{0}^{t} r ( w ( v ) ) dv - {\sum }_{j = 1}^{N ( t )} S ( w ( {τ}_{j} ) ) )}^{2} }{2 t {σ}^{2}} )$$

finally, a curve is drawn according to the reliability model for the lifetime and reliability prediction.

### III. Advantages of the Present Invention

The present invention considers effects of environment and load changes on the performance degradation process of product, namely considering the effect of time-varying environment on the degradation rate of product and the effect of effective shocks that caused by time-varying environment on degradation signal. The present invention makes the prediction method more realistic and improves the prediction accuracy.

### BRIEF DESCRIPTION OF THE DRAWINGS

FIG. 1 is a flow chart of the method of the present invention.

FIG. 2 illustrates effective shock of the present invention.

FIG. 3 is a simulation diagram of an environment and load profile of the present invention.

FIG. 4 is a simulation diagram of a product performance degradation curve obtained by the present invention.

FIG. 5 illustrates a product lifetime prediction reliability curve obtained by the present invention and a K-M curve for comparison.

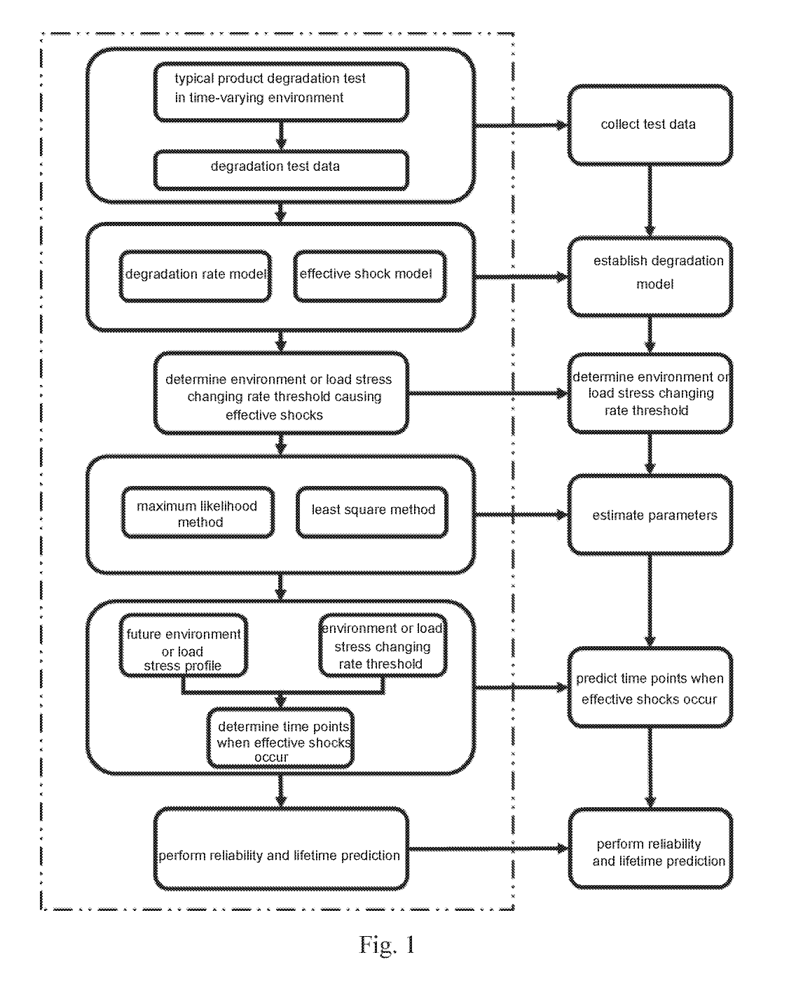

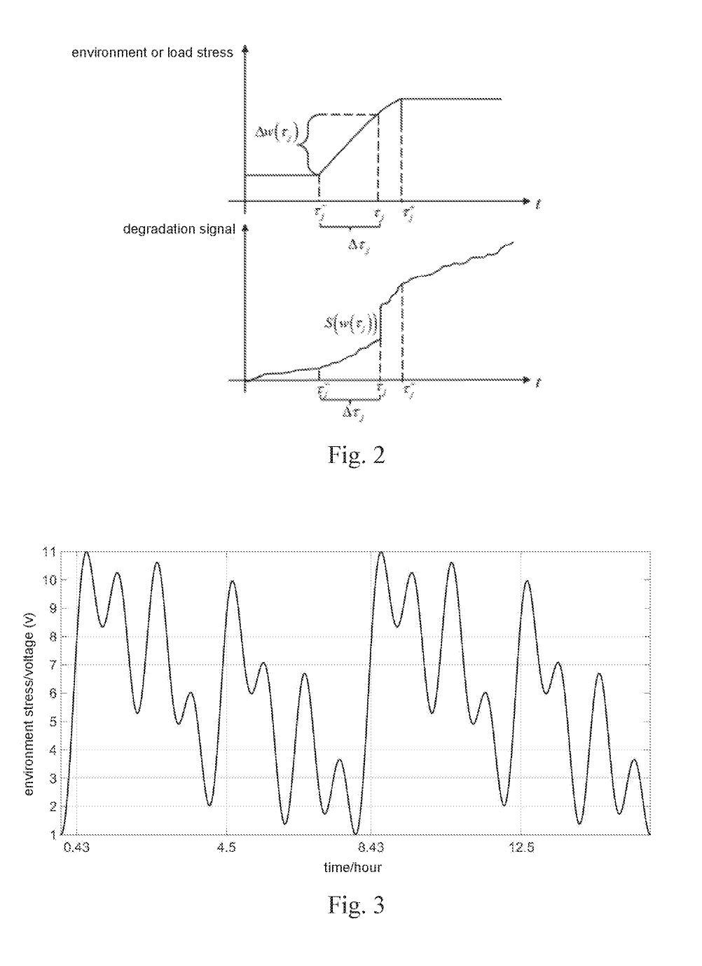

### DETAILED DESCRIPTION OF THE PREFERRED EMBODIMENT

The present invention uses a simulation method to verify its correctness. There assumed to be 100 products undergoing an 80-hour degradation test with a total of 800,000 data. FIG. 3 shows the environment (voltage) profile (for two cycles). In the simulation, a model is fitted based on the degradation data of the first 40 hour, and then reliability is predicted, wherein prediction accuracy is verified by failure data collected in the last 40 hours. It is assumed that the product performance degradation process follows Wiener process with a degradation rate cumulative effect function and an effective shock damage function, then the performance degradation process of product can be written as:

$$X ( t ) = X ( 0 ) + {\int }_{0}^{t} r ( w ( v ) ) dv + σ B ( t ) + {\sum }_{j = 1}^{N ( t )} S ( w ( {τ}_{j} ) )$$

wherein an initial value is assumed to be X(0)=0, a diffusion parameter is σ, and a degradation rate function is an inverse power law function r(w(t))=aw(t)^{b}. In this simulation test, we preset the degradation threshold D=5810, and parameter settings are shown in Table 1.

TABLE 1
parameter settings

| a | b | σ | α | β | D | l | γ |
|---|---|---|---|---|---|---|---|
| 1.7 | 2 | 4 | 30 | 0.5 | 5810 | 11.35 | 5.9 |

Application steps and the method of the present invention are described in detail below:

Step 1: Collecting Test Data

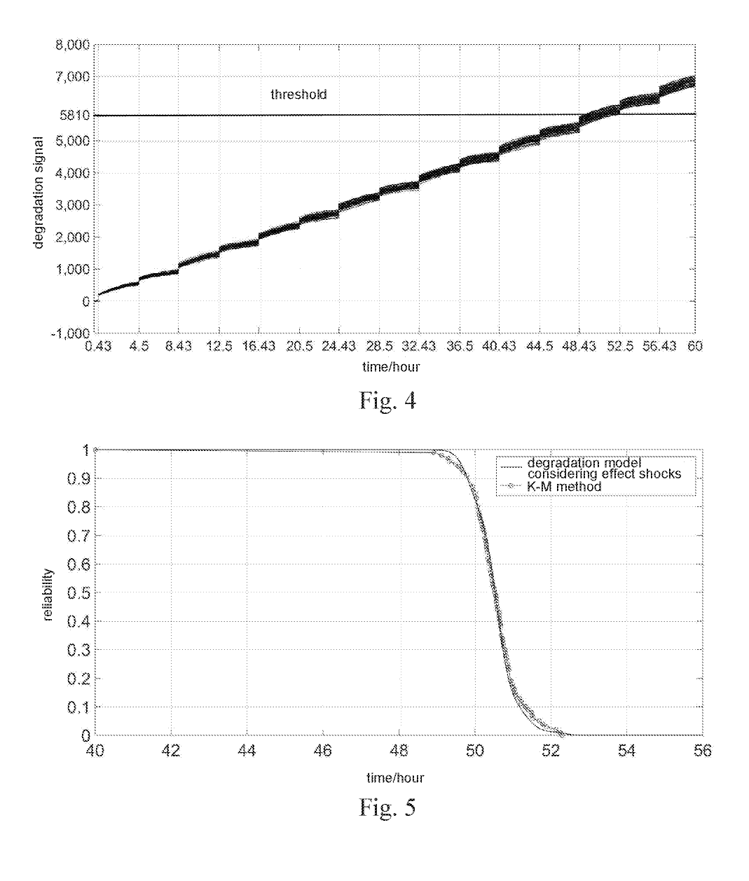

The test data are collected by simulation, and the performance degradation process is shown in FIG. 4.

Step 2: Establishing a Degradation Model

The product degradation process is fitted using the Wiener process with the degradation rate cumulative effect function and the effective shock damage function.

Step 3: Determining an Environment Stress Changing Rate Threshold

Based on historical data collected and the environmental profile, the environment stress changing rate threshold can be determined.

Firstly, the time periods of the effective shocks are determined according to the degradation data and the environment profile, and the corresponding environment stress average changing rates are calculated, wherein a minimum value w̅′ₘ=12.66 is taken as the upper limit of the threshold. Then the environment stress average changing rates of other monotonically increasing time periods of the environment stress where no effective shock are found, wherein a maximum value w̅′ₖ=10.04 is taken as the lower limit of the threshold. The mean value of the upper and lower limits is used to determine the environment stress changing rate threshold 1=11.35.

Step 4: Estimating the Parameters

The parameter estimation is performed using degradation data of the first 40 hours, and the parameters are estimated by a maximum likelihood method and a least square method.

Estimated results are shown in Table 2:

TABLE 2
estimates of parameters

| a | b | σ | α | β | γ |
|---|---|---|---|---|---|
| 1.6829 | 2.1034 | 4.0824 | 30 | 0.5 | 5.9 |

Step 5: Predicting the Effective Shock Occurrence Times

Based on the environment stress changing rate threshold and a future environmental profile, the times that effective shocks occur in the future can be predicted. The times that effective shocks occur are shown in Table 3:

TABLE 3
effective shock occurrence times

| τ₁ | τ₂ | τ₃ | τ₄ | τ₅ | τ₆ | τ₇ | τ₈ | τ₉ | τ₁₀ |
|---|---|---|---|---|---|---|---|---|---|
| 0.43 | 4.5 | 8.43 | 12.5 | 16.43 | 20.5 | 24.43 | 28.5 | 32.43 | 36.5 |
| τ₁₁ | τ₁₂ | τ₁₃ | τ₁₄ | τ₁₅ | τ₁₆ | τ₁₇ | τ₁₈ | τ₁₉ | τ₂₀ |
| 40.43 | 44.5 | 48.43 | 52.5 | 56.43 | 60.5 | 64.43 | 68.5 | 72.43 | 76.5 |

Step 6: Performing Reliability Prediction and Verifying

Estimates of parameters and the threshold D are substituted into the probability density function ƒ(t), and reliability can be calculated according to the reliability model R(t)=1−∫₀^{t}ƒ(ν)dν. Results are compared with those of a Kaplan-Meier (K-M) reliability prediction method based on failure times, so as to verify the accuracy of the prediction. The failure data are shown in Table 4:

TABLE 4
failure date (hour)

| | | | | | | | | |
|---|---|---|---|---|---|---|---|---|
| 48.92 | 49.13 | 49.29 | 49.32 | 49.49 | 49.58 | 49.65 | 49.7 | 49.79 |
| 49.81 | 49.88 | 49.9 | 49.92 | 49.95 | 49.99 | 50.01 | 50.03 | 50.05 |
| 50.09 | 50.12 | 50.18 | 50.22 | 50.23 | 50.29 | 50.31 | 50.33 | 50.34 |
| 50.39 | 50.42 | 50.44 | 50.49 | 50.52 | 50.53 | 50.59 | 50.62 | 50.64 |
| 50.72 | 50.79 | 50.85 | 50.91 | 50.92 | 50.94 | 50.98 | 51.01 | 51.05 |
| 51.06 | 51.07 | 51.09 | 51.18 | 51.22 | 51.25 | 51.36 | 51.42 | 51.58 |
| 51.61 | 51.65 | 51.71 | 51.73 | 51.75 | 51.81 | 51.83 | 51.95 | 51.99 |
| 52.1 | 52.15 | 52.18 | 52.19 | 52.21 | 52.24 | 52.3 | | |

Referring to FIG. 5, a reliability curve predicted based on the degradation model is very close to the curve predicted by a Kaplan-Meier method.

According to the above analysis, lifetime prediction using the method provided by the present invention not only considers the effect of the dynamic environment or load on the degradation rate, but also considers the effective shock on the product caused by sharp change of the environment or the load, which makes the prediction method more realistic and improves the prediction accuracy.

What is claimed is:

1. A degradation modeling and lifetime prediction method considering effective shocks, comprising steps of:
step 1: collecting test data
wherein product performance degradation data are collected through experiments or engineering applications; based on a time-varying environmental or a load profile, the product performance degradation data and corresponding environmental or load levels are acquired once in a pre-specified time interval, and then stored in real time;
step 2: establishing a degradation model
wherein a performance degradation model based on Wiener process including degradation rate function and effective shock function is expressed as follows:
$$X ( t ) = X ( 0 ) + {\int }_{0}^{t} r ( w ( v ) ) dv + σ B ( t ) + {\sum }_{j = 1}^{N ( t )} S ( w ( {τ}_{j} ) )$$
wherein X(0) is the value of degradation signal that describes product performance at an initial time; B(t) is a standard Wiener process;
σ is the diffusion parameter, which describes the inconsistency and instability in a product degradation process, and does not change with time and conditions, thus it is assumed to be a constant; σB(t)˜N(0,σ²t); w(t) is the level of environment or load at time t; ν is a variable in an integral formula, which has an upper limit of t and a lower limit of 0;
r(w(t)) is the product performance degradation rate, which is a deterministic function related to the environment and the load; when the environmental stress is electrical stress, the power law model r(w(t))=aw(t)^{b} can be utilized to describe the degradation rate; when the environmental stress is temperature, an Arrhenius model r(w(t))=ae^{-b/w(t)} is adopted;
S(w(τⱼ)) is the effect of effective shocks on degradation signals, wherein τⱼ is a time when the j-th effective shock occurs, j=1, 2, . . . , N(t), N(t) is the number of effective shocks occur until time t;
based on the above analysis, the time τⱼ that the j-th effective shock occurs is defined as:
$$\begin{matrix}{τ}_{j} = inf \{ {τ}_{j}^{-} \leq t \leq {τ}_{j}^{+} \text{:} \frac{γ}{( w ( t ) - w ( {τ}_{j}^{-} ) ) \text{/} ( t - {τ}_{j}^{-} )} + {τ}_{j}^{-} \leq t , \} \\ = inf \{ {τ}_{j}^{-} \leq t \leq {τ}_{j}^{+} \text{:} ( w ( t ) - w ( {τ}_{j}^{-} ) ) \geq γ \}\end{matrix}$$
wherein τⱼ⁻ and τⱼ⁺ are the start time and end time of a time period in which an environment or load changing rate is greater than a threshold value l, i.e., w′(t)≥l within a time interval [τⱼ⁻, τⱼ⁺], γ is a parameter to be estimated, w(t) is an environmental or load level at the time t, w(τⱼ⁻) is an environment or load level at the time τⱼ⁻;
an effective shock model is expressed as follows:
$$S ( w ( {τ}_{j} ) ) = α ( w ( {τ}_{j} ) - w ( {τ}_{j}^{-} ) ) exp ( - \frac{β}{( w ( {τ}_{j} ) - w ( {τ}_{j}^{-} ) ) \text{/} ( {τ}_{j} - {τ}_{j}^{-} )} )$$
wherein α and β are parameters to be estimated;
step 3: determining the environment or load changing rate threshold
3.1) according to engineering experience, effective shocks are considered only for the conditions that environment or load increases since effective shock is unlikely to occur when the environment or load decreases; according to an environmental or load profile, calculating the average changing rate w̅′ⱼ of a monotonically increasing time period of the environment or load stress, i=1, 2, . . . , n, which represents the i-th time period of a monotonically increasing environment or load stress profile;
3.2) finding the time periods during which the effective shock occurs according to historical degradation data, wherein the corresponding environment or load stress average changing rates are certainly greater than the threshold; on the contrary, environment or load average changing rates of other monotonically increasing time periods of the environment or load stress with no effective shock are less than the threshold, thereby estimating the environmental changing rate threshold based on historical data;
firstly, determining the time periods during which the effective shock occurs based on the degradation data, obtaining the corresponding environment or load stress average changing rates, and finding the minimum value w̅′ₘ, wherein w̅′ₘ is the minimum value of the environment or load changing rate that the effective shock occurs;
secondly, finding the environment or load average changing rate of other monotonically increasing time periods of the environment or load stress with no effective shock, and obtaining the maximum value w̅′ₖ, wherein w̅′ₖ is the maximum value of the environment or load changing rate that the effective shock does not occur; and
3.3) according to engineering applications, using the mean value of w̅′ₘ and w̅′ₖ as the environment or load changing rate threshold l,
$$l = {\overline{w}}_{k}^{′} + \frac{{\overline{w}}_{m}^{′} - {\overline{w}}_{k}^{′}}{2}$$
wherein for some special cases, the effective shock occurs in all environment or load time periods that environment or load stress increases, and thus it is impossible to determine the maximum value w̅′ₖ of the environment changing rate that the effective shock does not occur; therefore, the environment or load changing rate threshold l is set as the minimum value w̅′ₘ of the environment or load changing rate that the effective shock occurs,
l=w̅′ₘ
step 4: estimating the parameters and updating the model in real time
wherein a maximum likelihood method and a least square method are used to estimate the parameters, the power law model r(w(t))=aw(t)^{b} is taken as an example to describe the degradation rate, the degradation model is approximated as,
$$X ( t ) \approx X ( 0 ) + {\sum }_{i = 1}^{m} r ( w ( {t}_{i} ) ) Δ {t}_{i} + σ B ( t ) + {\sum }_{j = 1}^{N ( t )} S ( w ( {τ}_{j} ) )$$
wherein m is the cumulative observation number of degradation signals before time t, N(t) is the number of effective shocks occur before time t; w(tᵢ) is the environment or load level at the time tᵢ, r(w(tᵢ)) is the degradation rate at time tᵢ with environment or load level w(tᵢ), Δtᵢ is the time interval between tᵢ₋₁ and tᵢ;
the parameters α, β and γ in the effective shock model are estimated by the least square method,
first, the effective shock model is rewritten as,
ln(S(w(τⱼ)))−ln((w(τⱼ)−w(τⱼ⁻)))=ln(α)+{−(τⱼ−τⱼ⁻)/(w(τⱼ)−w(τⱼ⁻))}·β
denoting,
yⱼ=ln(S(w(τⱼ)))−ln((w(τⱼ)−w(τⱼ⁻)))
xⱼ=−(τⱼ−τⱼ⁻)/(w(τⱼ)−w(τⱼ⁻))
then estimates of the parameters are obtained as,
$$ln ( \hat{α} ) = \overline{y} - \hat{β} \overline{x}$$
$$\hat{β} = \frac{{\sum }_{j = 1}^{n} ( {x}_{j} - \overline{x} ) ( {y}_{j} - \overline{y} )}{{\sum }_{j = 1}^{n} {( {x}_{j} - \overline{x} )}^{2}}$$
$$\hat{γ} = \frac{1}{n} {\sum }_{j = 1}^{n} ( w ( {τ}_{j} ) - w ( {τ}_{j}^{′} ) )$$
$$wherein , \\ \overline{x} = \frac{1}{n} {\sum }_{j = 1}^{n} {x}_{j} = \frac{1}{n} {\sum }_{j = 1}^{n} [ - ( {τ}_{j} - {τ}_{j}^{-} ) \text{/} ( w ( {τ}_{j} ) - w ( {τ}_{j}^{-} ) ) ]$$
$$\overline{y} = \frac{1}{n} {\sum }_{j = 1}^{n} {y}_{j} = \frac{1}{n} {\sum }_{j = 1}^{n} [ ln ( S ( w ( {τ}_{j} ) ) ) - ln ( ( w ( {τ}_{j} ) - w ( {τ}_{j}^{-} ) ) ) ]$$
xⱼ, yⱼ, x and y are just established to simplify formula expressions;
the parameters in the degradation rate function and the diffusion parameter are estimated by the maximum likelihood method; in order to simplify calculation, effective shock cumulative damage terms in the data are subtracted:
$$H ( t ) = X ( t ) - {\sum }_{j = 1}^{N ( t )} S ( w ( {τ}_{j} ) )$$
wherein H(t) is the degradation model after subtracting effective shock cumulative damage;
then the degradation model is rewritten as,
$$H ( t ) \approx X ( 0 ) + {\sum }_{i = 1}^{m} r ( w ( {t}_{i} ) ) Δ {t}_{i} + σ B ( t )$$
based on the property that Wiener process has independent increments, then,
ΔH(tᵢ)≈r(w(tᵢ))Δtᵢ+σB(Δtᵢ)≈N(r(w(tᵢ))Δtᵢ,σ²Δtᵢ)
wherein ΔH (tᵢ) is the increment of the degradation signal;
the maximum likelihood method is used to estimate parameters and therefore the likelihood function of the degradation model is obtained:
$$L ( σ , a , b ) = {\prod }_{i = 1}^{m} \frac{1}{σ \sqrt{2 πΔ {t}_{i}}} exp [ - \frac{{( Δ H ( {t}_{i} ) - {a ( w ( {t}_{i} ) )}^{b} Δ {t}_{i} )}^{2}}{2 {σ}^{2} Δ {t}_{i}} ]$$
wherein the parameters α, β and γ are estimated by calculating first-order partial derivative of the log-likelihood function for each of the parameters, and further equalizing to 0;
step 5: predicting the time that effective shocks occur
wherein the time that effective shocks occurs are predicted before performing reliability and lifetime prediction;
according to the environment or load changing rate threshold l and a future environmental or load profile, the time that effective shocks occur can be predicted,
for the time periods when the environment or load changing rates are greater than the threshold l,
τⱼ⁻≤∀t≤τⱼ⁺,w′(t)≥l
the time that the j-th effective shock occurs τⱼ is predicted by performing a point-by-point analysis on the time t in the time period [τⱼ⁻, τⱼ⁺],
$${τ}_{j} = inf \{ {τ}_{j}^{-} \leq t \leq {τ}_{j}^{+} \text{:} \frac{γ}{( w ( t ) - w ( {τ}_{j}^{-} ) ) \text{/} ( t - {τ}_{j}^{-} )} + {τ}_{j}^{-} \leq t , \}$$
wherein τⱼ is the time when the j-th effective shock occurs;
if,
$$\frac{γ}{( w ( t ) - w ( {τ}_{j}^{-} ) ) \text{/} ( t - {τ}_{j}^{-} )} + {τ}_{j}^{-} \geq t , {τ}_{j}^{-} \leq t \leq {τ}_{j}^{+}$$
then no effective shock occurs before the time t; and
step 6: performing the lifetime and reliability prediction
wherein D is assumed to be the failure threshold and T is the time when the degradation signal exceeds the threshold for the first time; the product performance degradation data of products are collected through the experiment; tₖ is assumed to be the time point for collecting a last data set, tₖ<T, then w(t) represents a future environmental or load profile from tₖ to T, tₖ<t<T; thus, the degradation process based on the future environmental or load profile is expressed as:
$${X}^{k} ( t ) = X ( {t}_{k} ) + {\int }_{{t}_{k}}^{t} r ( w ( v ) ) dv + {\sum }_{j ∈ {V}_{k} ( t )}^{N ( t )} S ( w ( {τ}_{j} ) ) + σ B ( t - {t}_{k} )$$
wherein Vₖ(t)≡{j:τⱼ∈(tₖ,t]}, N(t) is the number of the effective shocks before the time t, X(tₖ) is the degradation value at the time tₖ;
then the distribution when the degradation value X(t) exceeds the threshold for the first time is expressed as:
T=inf{t>0:X(t)≥D}
then a reliability model is: R(t)=1−∫₀^{t} ƒ (ν)dν,
wherein ƒ(t) is the probability density function, in f(ν), ν is an independent variable with the upper limit of t and the lower limit of 0; an expression of ft) is obtained by applying a boundary tangent method of Daniels [Daniels, H. E. Approximating the first crossing-time density for a curved boundary, Bernoulli 2(2) (1996), 133-143] to estimate a tangential approximation method of a density function exceeding for a first time:
$$f ( t ) = \frac{1}{\sqrt{2 π t}} ( \frac{D - X ( 0 ) - {\int }_{0}^{t} r ( w ( v ) ) dv - {\sum }_{i = 1}^{N ( t )} S ( w ( {τ}_{j} ) ) + r ( w ( t ) ) t}{t σ} ) \cdot exp ( - \frac{{( D - X ( 0 ) - {\int }_{0}^{t} r ( w ( v ) ) dv - {\sum }_{j = 1}^{N ( t )} S ( w ( {τ}_{j} ) ) )}^{2} }{2 t {σ}^{2}} )$$
finally, a curve is drawn according to the reliability model for the lifetime and reliability prediction.
